(19) United States
(12) Patent Application Publication
(10) Pub. No.: US 2006/0150612 A1
(43) Pub. Date: Jul. 13, 2006

(54) Thrust vector control

(75) Inventors: Morris G. Anderson, Mesa, AZ (US); Mark Johnston, Scottsdale, AZ (US); Chad E. Knauer, Chandler, AZ (US)

Correspondence Address: Honeywell International, Inc.;Law Dept. AB2, P.O. Box 2245, Morristown, NJ, 07962-9806, US

(73) Assignee: Honeywell International Inc., Morristown, NJ (US)

(21) Appl. No.: 11/034,016

(22) Filed: Jan. 12, 2005

(51) Int. Cl. F02K 1/00

(52) U.S. Cl. 60/204; 60/228

(57) ABSTRACT

A thrust vector control system for a flight vehicle comprises a fixed nozzle defining a first thrust vector direction and at least one exhaust deflector moveable to a location downstream of said fixed nozzle to provide a second thrust vector direction. Movement of the at least one exhaust deflector may allow for simultaneous control of both thrust vector direction and nozzle throat area. Translational motion of each exhaust deflector may be independently controlled. A flight vehicle incorporating a thrust vector control apparatus, and a method for thrust vector control are also disclosed.

### BACKGROUND OF THE INVENTION

The present invention relates generally to apparatus and methods for thrust vector control, and more particularly to thrust vector control for a gas turbine engine of a flight vehicle.

Gas turbine engines for modern military and commercial aircraft use exhaust nozzles to control engine exhaust expansion and velocity distribution. By controlling engine exhaust expansion and velocity distribution, the engine exhaust nozzle provides relatively high thrust efficiency.

Conventional control of the discharge of the heated exhaust gas from a gas turbine engine may be achieved by varying the throat area of the nozzle. The throat area is defined as the minimum area through which the heated gas must pass to be discharged from the nozzle exit. For a convergent nozzle, the nozzle throat is typically the nozzle exit.

Prior art mechanisms for throat area control of an exhaust nozzle of a gas turbine engine are disclosed, for example, in U.S. Pat. No. 3,519,207 to Clough, and U.S. Pat. No. 3,837,577 to Perez Jr. However, neither the '207 nor the '577 teach a mechanism or method for control of thrust vector direction.

It is known in the art that thrust vector control may provide improved flight control to aircraft. Prior art thrust control systems for changing the nozzle convergent-divergent flow path are heavy and expensive, and require complex control mechanisms. For example, U.S. Pat. No. 6,369,527 to Feder et al. discloses a swiveling converging-diverging nozzle comprising a plurality of diverging flaps and converging flaps, wherein the converging flaps comprise alternating driven converging flaps and follower diverging flaps.

Fluidic nozzles have also been designed in the prior art, in an attempt to achieve thrust vector control, in which engine compressor bleed air has been injected into the nozzle flow path to deflect exhaust gas. Such fluidic nozzles require expensive piping systems to inject the bleed air into the nozzle exhaust gas flow. In addition, such fluidic designs are inefficient, difficult to control, and particularly unsuitable for low engine power applications, such as idle conditions.

As can be seen, there is a need for a system and method for thrust vector control of a flight vehicle, wherein the thrust vector control system has a relatively simple mechanical design, and yet effectively controls thrust vector direction, and provides smooth flight control over a broad range of engine power conditions.

### SUMMARY OF THE INVENTION

In one aspect of the present invention, a thrust vector control system comprises a fixed nozzle; and at least one exhaust deflector adapted for movement to a location downstream of the fixed nozzle, wherein the movement comprises translational motion, and the movement of each exhaust deflector is independently controllable.

In another aspect of the present invention, a thrust vector control system comprises a fixed nozzle having a fixed nozzle axis and a fixed nozzle exit, wherein the fixed nozzle axis defines a first thrust vector direction; and a single exhaust deflector is adapted for movement to a location downstream of the fixed nozzle exit to provide a second thrust vector direction.

In yet another aspect of the present invention, a thrust vector control system comprises a fixed nozzle for a gas turbine engine, the fixed nozzle having a fixed nozzle exit; and a thrust vector control apparatus including at least one exhaust deflector, each exhaust deflector adapted for independent translational motion, or a combination of translational and rotational motion, to a location downstream of the fixed nozzle exit, wherein the fixed nozzle provides a first thrust vector direction; and each exhaust deflector is adapted for converting the first thrust vector direction to a second thrust vector direction.

In still another aspect of the present invention, there is provided a system comprising a gas turbine engine having a fixed nozzle for discharging exhaust gas; at least one exhaust deflector, each exhaust deflector independently capable of changing a first thrust vector of the gas turbine engine, wherein each exhaust deflector is adapted for movement to a location downstream of the fixed nozzle; and an actuator adapted for actuating movement of each exhaust deflector, wherein the movement of each exhaust deflector is independently controllable, and the movement of each exhaust deflector comprises translational motion.

In a further aspect of the present invention, a thrust vector control apparatus comprises at least one deflection unit, each deflection unit including an exhaust deflector adapted for movement to a location downstream of a fixed nozzle of a gas turbine engine, wherein the fixed nozzle has a fixed nozzle axis; and an actuator in communication with the exhaust deflector, the actuator for actuating movement of each deflection unit, wherein the fixed nozzle provides a first thrust vector direction substantially parallel to the fixed nozzle axis, the movement of each exhaust deflector to the location downstream of the fixed nozzle comprises translational motion, and the movement of each exhaust deflector to the location downstream of the fixed nozzle provides a second thrust vector direction at a thrust vector angle, α to the fixed nozzle axis.

In yet a further aspect of the present invention, a flight vehicle comprises a gas turbine engine having a fixed nozzle; and a thrust vector control apparatus for controlling a thrust vector of the gas turbine engine, wherein the thrust vector control apparatus comprises at least one exhaust deflector, each exhaust deflector is independently controllable, and each exhaust deflector is movable with respect to a fixed nozzle exit of the fixed nozzle.

In still a further aspect of the present invention, a method for thrust vector control of a flight vehicle, comprises passing exhaust gas from a fixed nozzle of a gas turbine engine, the fixed nozzle having a fixed nozzle axis defining a first thrust vector direction; and moving at least one exhaust deflector to a location downstream of the fixed nozzle to provide a second thrust vector direction.

In yet another aspect of the present invention, a method for thrust vector control of a flight vehicle comprises providing a thrust vector control apparatus for the flight vehicle, wherein the flight vehicle includes a gas turbine engine having a fixed nozzle, the fixed nozzle having a fixed nozzle axis defining a first thrust vector direction substantially parallel to the fixed nozzle axis, and wherein the thrust vector control apparatus comprises at least one exhaust deflector. The method further comprises passing exhaust gas from the fixed nozzle, and moving the at least one exhaust deflector with respect to the fixed nozzle to provide a second thrust vector angle, α to the fixed nozzle axis, wherein moving the at least one exhaust deflector with respect to the fixed nozzle comprises translational motion of the at least one exhaust deflector to a location downstream of the fixed nozzle.

These and other features, aspects, and advantages of the present invention will become better understood with reference to the following drawings, description, and claims.

### BRIEF DESCRIPTION OF THE DRAWINGS

FIG. 1 is a block diagram schematically representing a flight vehicle incorporating a thrust vector control apparatus, according to the instant invention;

FIG. 2 is a block diagram schematically representing a thrust vector control system, according to the invention;

FIG. 3 is a block diagram schematically representing a thrust vector control apparatus, according to the invention;

FIGS. 4A-C each show a configuration of a deflection unit for a thrust vector control apparatus, according to the invention;

FIG. 5A is a side view schematic representation of a thrust vector control system having both a first exhaust deflector and a second exhaust deflector in a retracted position, according to the invention;

FIG. 5B is a side view schematic representation of a thrust vector control system having both a first exhaust deflector and a second exhaust deflector in an extended position, according to the invention;

FIG. 5C is a side view schematic representation of a thrust vector control system having a first exhaust deflector in an extended position, and a second exhaust deflector in a retracted position, according to the invention;

FIG. 5D is a side view schematic representation of a thrust vector control system having a first exhaust deflector in a retracted position, and a second exhaust deflector in an extended position, according to the invention;

FIG. 6 is a lateral cross-sectional view schematically representing a flight vehicle indicating a pitch plane and a yaw plane;

FIG. 7A schematically represents a series of steps involved in a method for thrust vector control of a flight vehicle, according to the invention; and

FIG. 7B schematically represents a series of steps involved in a method for thrust vector control of a flight vehicle, according to another embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides apparatus and methods for thrust vector control of a nozzle of a flight vehicle. The present invention may be used to change, or control, the thrust vector direction of, for example, a gas turbine engine. The present invention may also allow for simultaneous control of nozzle throat area and thrust vector direction. The present invention may be used for flight control of aircraft, including rotorcraft and fixed-wing aircraft, as well as rocket-propelled space vehicles, missiles, and the like. The present invention may also be used for flight control of tailless flight vehicles and unmanned flight vehicles.

In contrast to prior art fluidic nozzles, which inject bleed air into the nozzle flow path, and swiveling converging-diverging nozzles having a plurality of diverging flaps and converging flaps, the present invention comprises a fixed nozzle and one or more exhaust deflectors for movement by translational motion, or a combination of translational and rotational motion, to a location downstream of the fixed nozzle exit. In further contrast to prior art nozzles, which require piping systems for diverting bleed air to the nozzle, or the coordinated movement of several nozzle flaps simultaneously, the present invention may provide thrust vector control by movement of a single exhaust deflector, or alternatively by movement of at least one pair of exhaust deflectors, with respect to a fixed nozzle, wherein movement of each exhaust deflector may be independently controlled.

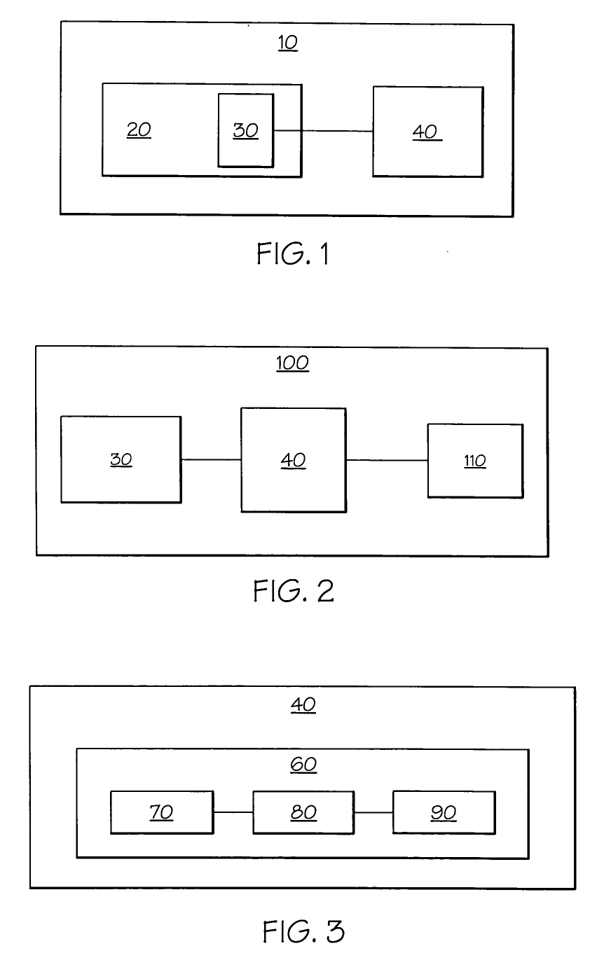

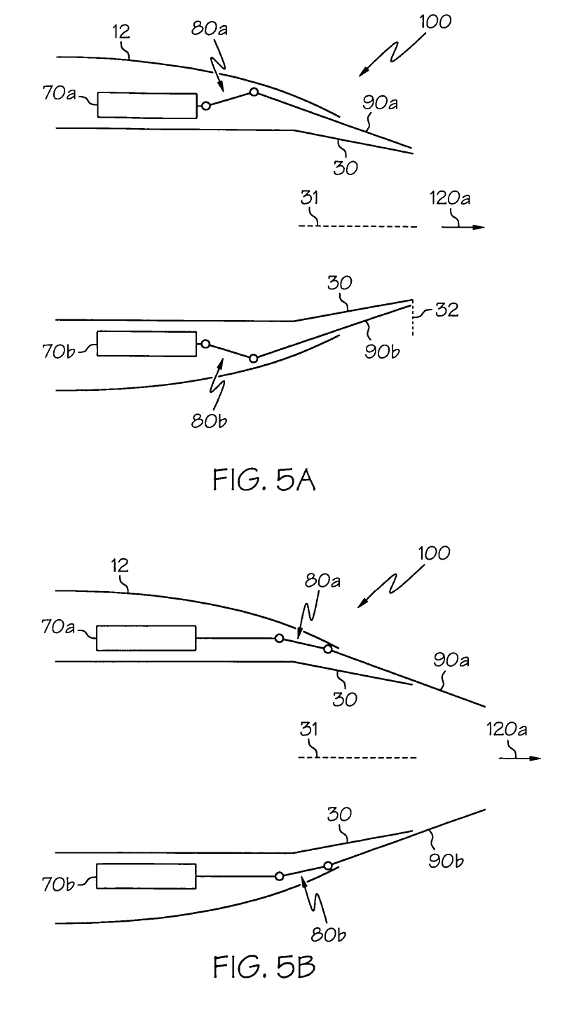

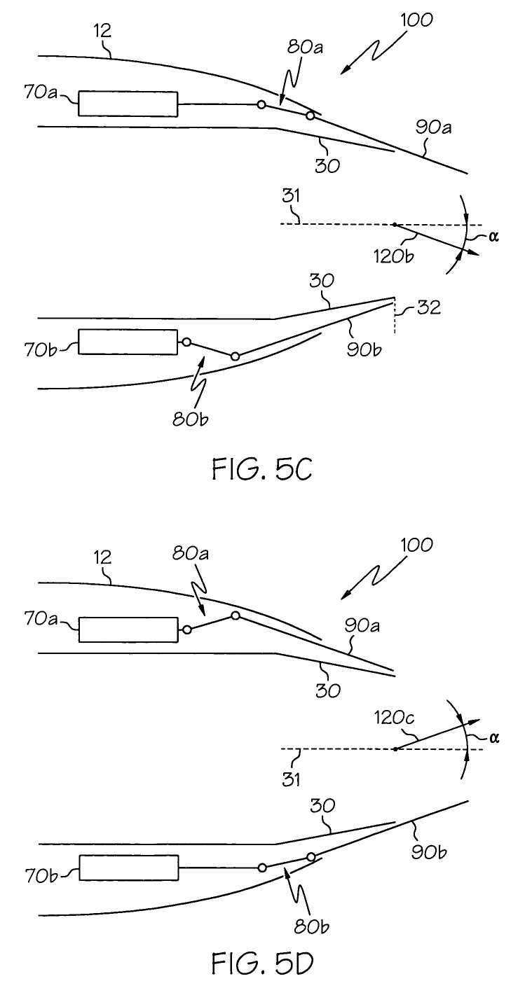

FIG. 1 is a block diagram schematically representing a flight vehicle 10, according to one aspect of the instant invention. Flight vehicle 10 may include one or more gas turbine engines 20. Gas turbine engine(s) 20 may comprise a conventional propulsion gas turbine engine for propulsion of flight vehicle 10. Each gas turbine engine 20 may have a fixed nozzle 30 for discharge of exhaust gases therefrom, thereby providing thrust for propulsion of flight vehicle 10. Fixed nozzle 30 may have a fixed nozzle axis 31 and a fixed nozzle exit 32 (see, for example, FIGS. 5A-D). Flight vehicle 10 may further include a thrust vector control apparatus 40, which may be adapted for use in conjunction with fixed nozzle 30.

Thrust vector control apparatus 40 may be used to change or control thrust vector direction of gas turbine engine 20. Flight vehicle 10 may be, for example, an aircraft, such as a rotorcraft or a fixed-wing aircraft, or a rocket-propelled space vehicle, a missile, or the like. Flight vehicle 10 may also be a tailless flight vehicle. Flight vehicle 10 may also be an unmanned flight vehicle (UAV). Thrust vector control apparatus 40 may have additional features and elements as described hereinbelow, for example, with reference to FIG. 3.

FIG. 2 is a block diagram schematically representing a thrust vector control system 100, according to one aspect of the invention. Thrust vector control system 100 may include a thrust vector control apparatus 40 adapted for use in conjunction with fixed nozzle 30, as described herein with reference to, e.g., FIGS. 1, 3, and 5A-D. Thrust vector control system 100 may include a controller 110 in communication with thrust vector control apparatus 40, wherein controller 40 may be adapted for controlling thrust vector control apparatus 40. As a non-limiting example, controller 40 may comprise a flight controller, such as a Digital Electronic Engine Control (DEEC) adapted for automated engine power management, or a Fully Automated Digital Electronic Control (FADEC). Such flight controllers are well known in the art.

FIG. 3 is a block diagram schematically representing a thrust vector control apparatus 40, according to the invention. Thrust vector control apparatus 40 may include one or more deflection units 60. Each gas turbine engine 20, and each fixed nozzle 30, may have one or a plurality of deflection units 60 for use in conjunction therewith. As an example, each deflection unit 60 may have one (1), two (2), or four (4) deflection units 60 for use in conjunction with each gas turbine engine 20/fixed nozzle 30.

Again with reference to FIG. 3, each deflection unit 60 may include an actuator 70, and an exhaust deflector 90 coupled to actuator 70. Deflection unit 60 may further include a linkage unit 80 for coupling exhaust deflector 90 to actuator 70. Deflection unit 60, including actuator 70, linkage unit 80, and exhaust deflector 90, may be housed radially outward from fixed nozzle 30 (see, e.g., FIGS. 5A-D). In alternative embodiments (not shown), deflection unit 60 may be at least partly disposed within fixed nozzle 30.

Each actuator 70 may be in signal, hydraulic, or electro-mechanical communication with controller 110 and linkage unit 80 for controlling movement of each exhaust deflector 90, wherein movement of each exhaust deflector 90 may be independently controlled. Each exhaust deflector 90 may be adapted for movement, e.g., by extending and retracting exhaust deflector 90, to and from a location aft, or downstream of, fixed nozzle 30, whereby a thrust vector direction of gas turbine engine 20 may be controlled (see, e.g., FIGS. 5A-D). Such movement of exhaust deflectors 90 for thrust vector control may typically comprise translational motion. In some embodiments of the invention, movement of exhaust deflectors 90 for thrust vector control may include a combination of rotational and translational motion.

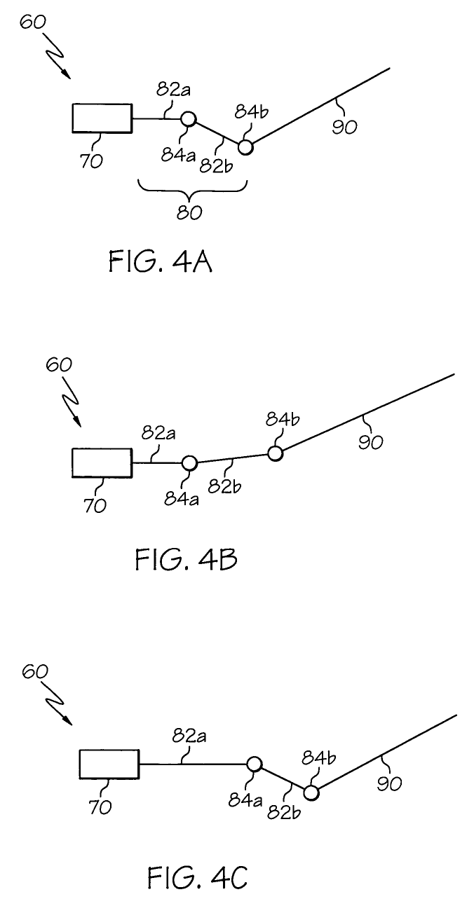

FIGS. 4A-C each show a configuration of a deflection unit 60 for a thrust vector control apparatus 40, according to the invention. Deflection unit 60 may comprise an actuator 70 coupled to an exhaust deflector 90 via a linkage unit 80. Linkage unit 80 may comprise one or more segments and one or more articulation units. As an example, linkage unit 80 may include first and second segments 82a, 82b, and first and second articulation units 84a, 84b. First and second segments 82a, 82b and exhaust deflector 90 may each be of fixed or variable lengths. For example, one or both of first and second segments 82a, 82b may be extendible (see, FIG. 4C). Articulation units 84a, 84b may each define an articulation point, or pivot point, for deflection unit 60, and articulation units 84a, 84b may comprise one or more hinges, and the like. Other numbers and arrangements of segments and articulation units are possible under the invention. Movement of exhaust deflector 90 and linkage unit 80 may be actuated via actuator 70 by various mechanisms well known in the art. Other configurations for independently controlling movement of exhaust deflector(s) 90 with respect to fixed nozzle 30 are also within the scope of the invention.

FIG. 4A shows deflection unit 60 in a retracted or partially retracted configuration. In such a retracted or partially retracted configuration, exhaust deflector 90 may not extend downstream of fixed nozzle exit 32; and accordingly, exhaust deflector 90 may not influence a default or first thrust vector direction of fixed nozzle 30, wherein the first thrust vector direction may be axial or substantially axial (see, e.g., FIG. 5A).

FIG. 4B shows deflection unit 60 in an extended or partially extended configuration, such that exhaust deflector 90 may extend downstream of fixed nozzle exit 32 (see, e.g., FIG. 5B-D). FIG. 4C shows a configuration of deflection unit 60 in which first segment 82a is extended from actuator 70. It will be readily apparent to the skilled artisan that other configurations of deflection unit 60 are possible, for example, by a combination of extension and articulation of one or more of first and second segments 82a, 82b, in order to provide a large variety of positions of exhaust deflector 90 with respect to fixed nozzle exit 32 (see, e.g., FIG. 5C). Exhaust deflectors 90, which may be adapted for deflecting exhaust gas discharged from nozzle 30, may be planar or non-planar.

FIG. 5A is a side view schematic representation of a thrust vector control system 100 showing a first exhaust deflector 90a and a second exhaust deflector 90b in relation to fixed nozzle 30. Thrust vector control system 100 may include a first actuator 70a coupled to first exhaust deflector 90a via a first linkage unit 80a, and a second actuator 70b coupled to second exhaust deflector 90b via a second linkage unit 80b. A vehicle structure 12 may at least partially enclose nozzle 30. Structure 12 may comprise, for example, an engine nacelle or an aircraft skin. First and second actuators 70a, 70b and/or first and second linkage units 80a, 80b may be affixed to vehicle structure 12.

In FIG. 5A, first and second exhaust deflectors 90a, 90b are shown in a retracted position, e.g., first and second exhaust deflectors 90a, 90b are not downstream of fixed nozzle exit 32, such that the effective throat area is maximal and a first thrust vector direction 120a is substantially parallel to nozzle axis 31. For example, when first and second exhaust deflectors 90a, 90b are in the configuration shown in FIG. 5A, first thrust vector direction 120a may deviate from the direction of nozzle axis 31 by 5° or less, and usually first thrust vector direction 120a may deviate from the direction of nozzle axis 31 by 2° or less.

FIG. 5B is a side view schematic representation of a thrust vector control system having both first exhaust deflector 90a and second exhaust deflector 90b in an extended or partially extended position, according to the invention. Although both first and second exhaust deflectors 90a, 90b are shown in FIG. 5B as downstream of fixed nozzle exit 32, movement of each of first and second exhaust deflectors 90a, 90b may be independently controlled (see, e.g., FIGS. 5C-D). The configuration of first and second exhaust deflectors 90a, 90b shown in FIG. 5B effectively decreases throat area as compared with FIG. 5A, although the configuration of FIG. 5B may maintain first thrust vector direction 120a at least substantially as for FIG. 5A.

FIG. 5C is a side view schematic representation of thrust vector control system 100 in which first exhaust deflector 90a is extended to a location downstream of fixed nozzle exit 32, while second exhaust deflector 90b is not downstream of fixed nozzle exit 32, such that only first exhaust deflector 90a is in a position to deflect exhaust gas discharged from nozzle 30. The configuration of FIG. 5C provides a second thrust vector direction indicated as 120b, wherein second thrust vector direction 120b defines a thrust vector angle, α with respect to nozzle axis 31. Typically, thrust vector angle, α may be in the range of from about 0° to 30°, usually from about 0° to 20°, and often from about 0° to 15°.

FIG. 5D is a side view schematic representation of thrust vector control system 100 in which second exhaust deflector 90b is extended to a location downstream of fixed nozzle exit 32, while first exhaust deflector 90a is not downstream of fixed nozzle exit 32, such that only second exhaust deflector 90a is in a position to deflect exhaust gas discharged from nozzle 30. The configuration of FIG. 5D may provide a third thrust vector direction, indicated as 120c, which subtends thrust vector angle, α to nozzle axis 31. It is to be understood that intermediate positions, between fully extended and fully retracted, are within the scope of the invention for each exhaust deflector, e.g., first exhaust deflector 90a, and second exhaust deflector 90b. For example, with reference to FIG. 5D, first exhaust deflector 90a may be partially extended, to a position intermediate between the retracted position of FIG. 5A and the extended position of FIG. 5B. Such partial extension of first exhaust deflector 90a may serve to decrease nozzle throat area, e.g., as compared with FIG. 5D. At the same time, such partial extension of first exhaust deflector 90a may serve to decrease thrust vector angle, α, as compared with that shown in FIG. 5D. Thus, the present invention may allow simultaneous control over both nozzle throat area and thrust vector direction. It is to be understood that the invention is not limited to the configurations, or actuation mechanisms, shown in FIGS. 5A-D, but instead other configurations and actuation mechanisms for thrust vector control are also within the scope of the invention. Fixed nozzle exit 32 may be circular or substantially circular. Alternatively, fixed nozzle exit 32 may be substantially flattened in one or more planes.

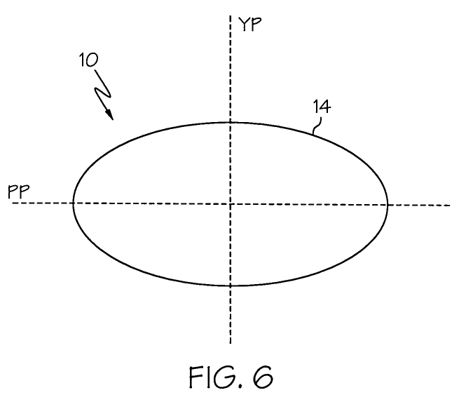

FIG. 6 is a lateral cross-sectional view schematically representing a flight vehicle 10 having a vehicle skin 14, and indicating a pitch plane, PP and a yaw plane, YP of flight vehicle 10. Thrust vector directions 120b, 120c of FIGS. 5C and 5D may be in the pitch plane, PP or the yaw plane, YP. When thrust vector directions 120b, 120c are in the yaw plane of flight vehicle 10, the configurations of FIGS. 5C and 5D may give a tail-up force and a tail-down force, respectively. Alternatively, when thrust vector directions 120b, 120c are in the pitch plane of flight vehicle 10, the configurations of FIGS. 5C and 5D may give a force to the left and a force to the right, respectively. In alternative embodiments, exhaust deflectors 90, e.g., first and second exhaust deflectors 90a, 90b, may be configured such that a thrust vector direction may be obtained in any plane (not shown) between the pitch plane and the yaw plane.

In some embodiments, thrust vector control system 100 may comprise a single exhaust deflector 90, e.g., exhaust deflector 90a. In other embodiments, thrust vector control system 100 may comprise a pair of exhaust deflector 90, e.g., first and second exhaust deflectors 90a, 90b, wherein first and second exhaust deflectors 90a, 90b may be diametrically opposed. In still other embodiments (not shown), thrust vector control system 100 may comprise two pairs, or a total of four (4), exhaust deflectors 90, wherein each pair may be diametrically opposed. It is to be understood that the invention is not limited to a single exhaust deflector 90, nor to pairs of exhaust deflectors 90, and that other numbers and arrangements of exhaust deflectors 90 are also possible under the invention. Typically, each of a plurality of such exhaust deflectors 90 may be independently controlled during flight of flight vehicle 10 for efficient thrust vector control.

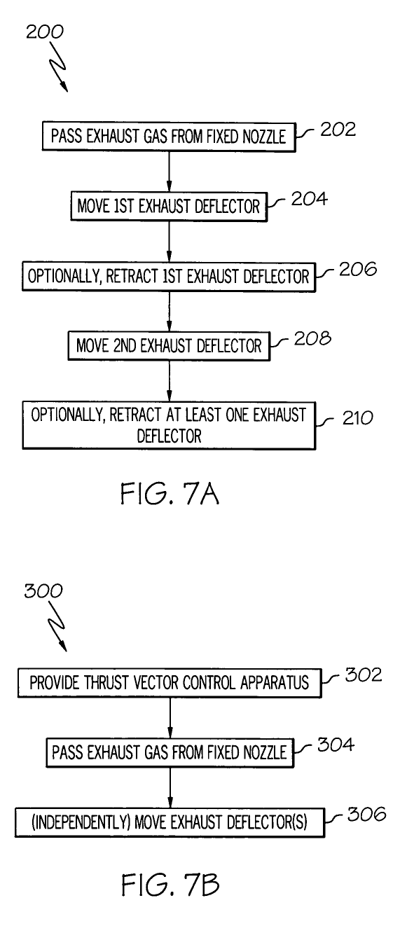

FIG. 7A schematically represents a method 200 for thrust vector control of a flight vehicle, according to the invention, wherein step 202 may involve passing exhaust gas from a fixed nozzle to provide a first thrust vector having a first thrust vector direction. As a non-limiting example, the fixed nozzle may be that of a propulsion gas turbine engine for a flight vehicle. The fixed nozzle may have a fixed nozzle axis, which may define the first thrust vector direction. The first thrust vector direction may be parallel, or substantially parallel, to the fixed nozzle axis. The first thrust vector direction may provide axial thrust. The fixed nozzle may have a fixed nozzle exit. The fixed nozzle exit may define the most aft, or downstream, portion of the fixed nozzle.

Step 204 may involve moving a first exhaust deflector with respect to the fixed nozzle. The first exhaust deflector may be coupled, e.g., via a linkage unit, to an actuator of a thrust vector control apparatus. The thrust vector control apparatus may have elements, features, and characteristics as described hereinabove, e.g., with reference to FIGS. 1-6. Step 204 may involve moving the first exhaust deflector to a location downstream of the fixed nozzle exit. Step 204 may involve moving the first exhaust deflector with respect to the fixed nozzle such that the first exhaust deflector deflects the flow path of the exhaust gas discharged from the fixed nozzle. Step 204 may thus provide a second thrust vector having a second thrust vector direction. Step 204 may also involve moving the first exhaust deflector with respect to the fixed nozzle exit such that the effective throat area is decreased. Accordingly, a magnitude of the second thrust vector may be changed. Thus, the present invention may allow for simultaneous control over both thrust vector magnitude and thrust vector direction.

Movement of the first exhaust deflector may be actuated by an actuator under the control of a controller, such as an automated flight controller (e.g., a FADEC). Movement of the first exhaust deflector with respect to the fixed nozzle may be accomplished by articulation and/or extension of one or more segments of the linkage unit. Movement of the first exhaust deflector in step 204 may be in the form of translational motion only. Stated differently, movement of the first exhaust deflector may be in a straight line so that every point on the first exhaust deflector follows a parallel path and no rotation takes place. In alternative embodiments of the invention, movement of the first exhaust deflector in step 204 may include a combination of rotational and translational motion.

The second thrust vector direction may be at a thrust vector angle, a to the nozzle axis. The thrust vector angle, α may typically be in the range of from about 0° to 30°, usually from about 0° to 20°, and often from about 0° to 15°. Depending on the orientation of the first exhaust deflector, the second thrust vector direction may provide a tail-up force, a tail-down force, a force to the left, or a force to the right. The first exhaust deflector may be configured with respect to the fixed nozzle to provide the second thrust vector direction in the pitch plane, the yaw plane, or any plane between the pitch plane and the yaw plane.

Optional step 206 may involve retracting the first exhaust deflector such that the first exhaust deflector is no longer downstream of the fixed nozzle exit. Step 206 may involve reverting from the second thrust vector direction to the first thrust vector direction. Alternatively, step 206 may involve partially retracting the first exhaust deflector such that the second thrust vector direction may be varied, for example, according to the required flight control conditions for the flight vehicle.

Step 208 may involve moving a second exhaust deflector with respect to the fixed nozzle. In some embodiments of the invention, moving the second exhaust deflector in step 208 may be in the form of translational motion alone, or may include a combination of both rotational and translational motion. Movement of the second exhaust deflector in step 208 may substantially mirror movement of the first exhaust deflector as described for step 204. For example, step 208 may involve moving the second exhaust deflector to a location downstream of the fixed nozzle exit such that the second exhaust deflector deflects the flow path of the exhaust gas discharged from the fixed nozzle. Movement of the second exhaust deflector in step 208 to a location downstream of the fixed nozzle exit may provide a third thrust vector direction.

In step 208, the second exhaust deflector may be moved to a location downstream of the fixed nozzle exit independently of the first exhaust deflector. For example, the second exhaust deflector may be moved to a location downstream of the fixed nozzle exit at a time when the first exhaust deflector is partially or fully retracted, or the second exhaust deflector may be moved to a location downstream of the fixed nozzle exit at a time when the first exhaust deflector is also located downstream of the fixed nozzle exit. In this way, the present invention may allow simultaneous control over both nozzle throat area and thrust vector direction.

Optional step 210 may involve at least partially retracting at least one of the first and second exhaust deflectors to control the thrust vector direction according to the required flight control conditions. In additional steps (not shown), one or more additional exhaust deflectors may be extended into, or retracted from, the exhaust flow path of the fixed nozzle to provide appropriate thrust vector control. Movement of each exhaust deflector may be independently controlled, for example, by an automated flight controller.

FIG. 7B schematically represents a method 300 for thrust vector control of a flight vehicle, according to another embodiment of the invention, wherein step 302 may involve providing thrust vector control apparatus for a flight vehicle. The thrust vector control apparatus provided in step 302 may have various elements, features, and characteristics as described herein with respect to FIGS. 1-7A.

In some embodiments, step 302 may involve retrofitting a flight vehicle with the thrust vector control apparatus. In alternative embodiments of the invention, the thrust vector control apparatus may be integral with a flight vehicle. The flight vehicle may be, for example, an aircraft, which may have a tail, such as a fixed-wing aircraft, or a rotorcraft; a tailless flight vehicle; or an unmanned air vehicle (UAV), and the like.

Step 304 may involve passing exhaust gas from a fixed nozzle to provide thrust having a first thrust vector direction which may be substantially axial. Step 306 may involve independently moving one or more exhaust deflectors with respect to the fixed nozzle to vary the thrust vector direction. The thrust vector direction may be varied to provide a thrust vector angle, α to the fixed nozzle axis, typically in the range of from about 0° to 30°. Step 306 may involve translational motion of a single exhaust deflector to a location downstream of the fixed nozzle. Alternatively, step 306 may involve translational motion of two or more exhaust deflectors. In some embodiments of the invention, the two or more exhaust deflectors may comprise at least one pair of diametrically opposed exhaust deflectors.

The thrust vector control system of the present invention may provide thrust vector control for gas turbine engines at all engine power settings (e.g., take-off, cruise, idle), and may provide high thrust coefficients, typically at least 95%, at pressure ratios equal to or less than 6.0. Accordingly, the present invention may provide smooth flight control with minimal or no unsteady, or separated, flow within the exhaust nozzle flow-path.

In addition to providing control of thrust vector direction, the present invention may also allow for control of nozzle throat area, including such control of nozzle throat area independently of thrust vector direction control.

Although the invention has been described primarily with respect to thrust vector control for a gas turbine engine, the present invention may also find applications in thrust vector control for rocket-propelled space vehicles, missiles, and the like.

It should be understood, of course, that the foregoing relates to exemplary embodiments of the invention and that modifications may be made without departing from the spirit and scope of the invention as set forth in the following claims.

We claim:

1. A thrust vector control system, comprising:
a fixed nozzle; and
at least one exhaust deflector adapted for movement to a location downstream of said fixed nozzle, wherein:
said movement comprises translational motion, and said movement of each said exhaust deflector is independently controllable.

2. The thrust vector control system of claim 1, wherein:
said fixed nozzle provides a first thrust vector direction,
said at least one exhaust deflector is capable of providing a second thrust vector direction, and
said second thrust vector direction is different from said first thrust vector direction.

3. The thrust vector control system of claim 2, wherein:
said fixed nozzle defines a fixed nozzle axis,
said first thrust vector direction is substantially parallel to said fixed nozzle axis,
said second thrust vector direction is at a thrust vector angle, α to said fixed nozzle axis, and
said thrust vector angle is in the range of from about 0 to 30°.

4. The thrust vector control system of claim 1, wherein said exhaust deflector is planar.

5. The thrust vector control system of claim 1, wherein said exhaust deflector is non-planar.

6. The thrust vector control system of claim 1, wherein said exhaust deflector is disposed radially outward from said fixed nozzle.

7. The thrust vector control system of claim 1, further comprising at least one actuator coupled to said exhaust deflector.

8. The thrust vector control system of claim 7, further comprising at least one linkage unit, each said linkage unit adapted for coupling each said actuator to each said exhaust deflector.

9. The thrust vector control system of claim 7, further comprising a controller in communication with each said actuator, wherein said controller is adapted for independently controlling each said actuator.

10. The thrust vector control system of claim 1, wherein said at least one exhaust deflector comprises a pair of said exhaust deflectors.

11. The thrust vector control system of claim 1, wherein said fixed nozzle is a convergent nozzle.

12. The thrust vector control system of claim 1, wherein said exhaust deflector is adapted for simultaneously controlling nozzle throat area and thrust vector direction.

13. The thrust vector control system of claim 1, wherein said movement comprises rotational motion in combination with said translational motion.

14. The thrust vector control system of claim 1, wherein said movement of said exhaust deflector to said location downstream of said fixed nozzle is movement in a straight line so that every point on said exhaust deflector follows a parallel path and no rotation takes place.

15. A thrust vector control system, comprising:
a fixed nozzle having a fixed nozzle axis and a fixed nozzle exit, said fixed nozzle axis defining a first thrust vector direction; and
a single exhaust deflector adapted for movement to a location downstream of said fixed nozzle exit to provide a second thrust vector direction.

16. The thrust vector control system of claim 15, wherein:
said second thrust vector direction is at a thrust vector angle, α to said first thrust vector direction,
said first thrust vector direction is substantially parallel to said fixed nozzle axis, and
said thrust vector angle is from about 0° to 30°.

17. The thrust vector control system of claim 15, further comprising at least one additional exhaust deflector adapted for movement to a location downstream of said fixed nozzle exit to provide a third thrust vector direction.

18. The thrust vector control system of claim 17, further comprising:
at least one actuator; and
at least one linkage unit for coupling each said actuator to each said exhaust deflector, wherein:
each said linkage unit comprises a plurality of segments, and
at least one of said segments is articulated.

19. A thrust vector control system, comprising:
a fixed nozzle for a gas turbine engine, said fixed nozzle having a fixed nozzle exit; and
a thrust vector control apparatus including at least one exhaust deflector, each said exhaust deflector adapted for independent translational motion to a location downstream of said fixed nozzle exit, wherein:
said fixed nozzle provides a first thrust vector direction; and
each said exhaust deflector is adapted for converting said first thrust vector direction to a second thrust vector direction.

20. The thrust vector control system of claim 19, wherein:
said fixed nozzle is a convergent nozzle having a fixed nozzle axis,
said first thrust vector direction is substantially parallel to said fixed nozzle axis,
said second thrust vector direction is at a thrust vector angle, α to said fixed nozzle axis, and
said thrust vector angle is from about 0° to 30°.

21. The thrust vector control system of claim 20, wherein said thrust vector angle is from about 0° to 15°.

22. A system, comprising:
a gas turbine engine having a fixed nozzle for discharging exhaust gas;
at least one exhaust deflector, each said exhaust deflector independently capable of changing a first thrust vector of said gas turbine engine, each said exhaust deflector adapted for movement to a location downstream of said fixed nozzle; and
an actuator adapted for actuating said movement of each said exhaust deflector, wherein:
said movement of each said exhaust deflector is independently controllable, and
said movement of each said exhaust deflector comprises translational motion.

23. The system of claim 22, wherein:
said fixed nozzle has a fixed nozzle axis and a nozzle exit,
said fixed nozzle axis defines said first thrust vector having a first thrust vector direction substantially parallel to said fixed nozzle axis, and
said movement of each said exhaust deflector to said location downstream of said fixed nozzle provides a second thrust vector having a second thrust vector direction at a thrust vector angle, α to said fixed nozzle axis, wherein said thrust vector angle is from about 0° to 30°.

24. The system of claim 22, wherein:
said gas turbine engine is a propulsion gas turbine engine for propulsion of a flight vehicle, and said system has one (1), two (2), or four (4) of said exhaust deflectors for each said gas turbine engine.

25. The system of claim 24, wherein said system has two (2) said exhaust deflectors for each said gas turbine engine.

26. The system of claim 23, wherein said second thrust vector provides an upward force, a downward force, a force to the right, or a force to the left.

27. The system of claim 22, further comprising:
a linkage unit for coupling each said exhaust deflector to said actuator, and
a controller in communication with said actuator,
wherein said controller is adapted for independently controlling said movement of each said exhaust deflector.

28. A thrust vector control apparatus, comprising:
at least one deflection unit, each said deflection unit including:
an exhaust deflector adapted for movement to a location downstream of a fixed nozzle of a gas turbine engine, said fixed nozzle having a fixed nozzle axis, and
an actuator in communication with said exhaust deflector, said actuator for actuating said movement, wherein:
said fixed nozzle provides a first thrust vector direction substantially parallel to said fixed nozzle axis,
said movement of each said exhaust deflector to said location downstream of said fixed nozzle comprises translational motion, and
said movement of each said exhaust deflector to said location downstream of said fixed nozzle provides a second thrust vector direction at a thrust vector angle, α to said fixed nozzle axis.

29. The thrust vector control apparatus of claim 28, wherein:
said deflection unit further includes a linkage unit for coupling said exhaust deflector unit to said actuator, and
said linkage unit comprises at least one articulated segment.

30. The thrust vector control apparatus of claim 28, wherein said actuator is adapted for control by a flight controller.

31. The thrust vector control apparatus of claim 28, wherein said exhaust deflector comprises at least one diametrically opposed pair of said exhaust deflectors.

32. The thrust vector control apparatus of claim 28, wherein said movement of said exhaust deflector to said location downstream of said fixed nozzle is movement in a straight line so that every point on said exhaust deflector follows a parallel path and no rotation takes place.

33. The thrust vector control apparatus of claim 28, wherein said movement of said exhaust deflector to said location downstream of said fixed nozzle comprises rotational motion in combination with said translational motion.

34. A flight vehicle, comprising:
a gas turbine engine having a fixed nozzle; and
a thrust vector control apparatus for controlling a thrust vector of said gas turbine engine, wherein:
said thrust vector control apparatus comprises at least one exhaust deflector,
each said exhaust deflector is independently controllable, and
each said exhaust deflector is movable with respect to a fixed nozzle exit of said fixed nozzle.

35. The flight vehicle of claim 34, wherein:
said fixed nozzle defines a fixed nozzle axis,
said fixed nozzle is adapted for discharging an exhaust gas in a substantially axial direction to provide a first thrust vector having a first thrust vector direction,
each said exhaust deflector is adapted for translational motion to a location downstream of said fixed nozzle exit,
each said exhaust deflector is adapted for providing a second thrust vector having a second thrust vector direction, and
said second thrust vector is different from said first thrust vector direction.

36. The flight vehicle of claim 34, wherein each said exhaust deflector is adapted for providing nozzle throat area control simultaneously with providing said second thrust vector direction.

37. The flight vehicle of claim 35, wherein:
said second thrust vector direction defines a thrust vector angle, a to said fixed nozzle axis, and
said thrust vector angle is from about 0° to 30°.

38. The flight vehicle of claim 35, wherein said second thrust vector direction is in the pitch plane of said flight vehicle or the yaw plane of said flight vehicle.

39. The flight vehicle of claim 35, wherein said second thrust vector direction is in any plane between the pitch plane and the yaw plane of said flight vehicle.

40. The flight vehicle of claim 34, further comprising a flight controller in communication with said thrust vector control apparatus for independently controlling movement of said at least one exhaust deflector.

41. The flight vehicle of claim 34, comprising a rotorcraft or a fixed-wing aircraft.

42. The flight vehicle of claim 34, comprising an unmanned air vehicle.

43. A method for thrust vector control of a flight vehicle, comprising:
a) passing exhaust gas from a fixed nozzle of a gas turbine engine, said fixed nozzle having a fixed nozzle axis defining a first thrust vector direction; and
b) moving at least one exhaust deflector to a location downstream of said fixed nozzle to provide a second thrust vector direction.

44. The method of claim 43, wherein:
said first thrust vector direction is substantially parallel to said fixed nozzle axis, and
said second thrust vector direction is at a thrust vector angle, α to said fixed nozzle axis.

45. The method of claim 44, wherein said thrust vector angle is from about 0° to 30°.

46. The method of claim 43, wherein said step a) provides a first thrust vector, and said step b) provides a second thrust vector, wherein said second thrust vector provides a tail-up force to said flight vehicle, or a tail-down force to said flight vehicle.

47. The method of claim 43, wherein said step a) provides a first thrust vector, and said step b) provides a second thrust vector, wherein said second thrust vector provides a force to the left to said flight vehicle, or a force to the right to said flight vehicle.

48. The method of claim 43, wherein said at least one exhaust deflector comprises a first exhaust deflector and a second exhaust deflector, wherein said first exhaust deflector and said second exhaust deflector are independently movable with respect to said fixed nozzle.

49. The method of claim 48, wherein said first exhaust deflector and said second exhaust deflector are disposed on opposing sides of said fixed nozzle.

50. The method of claim 43, wherein said at least one exhaust deflector comprises a first exhaust deflector, and the method further comprises:
c) retracting said first exhaust deflector such that said first exhaust deflector is not disposed downstream of said fixed nozzle; and
d) moving a second exhaust deflector such that said second exhaust deflector is disposed downstream of said fixed nozzle to provide a third thrust vector direction.

51. The method of claim 43, wherein said at least one exhaust deflector comprises a first exhaust deflector, and the method further comprises:
e) moving a second exhaust deflector such that said second exhaust deflector is disposed downstream of said fixed nozzle, wherein said step a) provides a first thrust vector magnitude, and said steps b) and e) provide a second thrust vector magnitude.

52. The method of claim 51, further comprising:
f) retracting at least one of said first exhaust deflector and said second exhaust deflector.

53. The method of claim 43, wherein said step b) comprises moving a single one of said at least one exhaust deflector.

54. The method of claim 43, wherein said step b) comprises translational motion of said at least one exhaust deflector.

55. The method of claim 43, wherein said step b) comprises providing nozzle throat area control simultaneously with providing said second thrust vector direction.

56. A method for thrust vector control of a flight vehicle, comprising:
a) providing a thrust vector control apparatus for said flight vehicle, wherein said flight vehicle includes a gas turbine engine having a fixed nozzle, said fixed nozzle having a fixed nozzle axis defining a first thrust vector direction substantially parallel to said fixed nozzle axis, and wherein said thrust vector control apparatus comprises at least one exhaust deflector;
b) passing exhaust gas from said fixed nozzle; and
c) moving said exhaust deflector with respect to said fixed nozzle to provide a second thrust vector angle, α to said fixed nozzle axis, wherein said step c) comprises translational motion of said at least one exhaust deflector to a location downstream of said fixed nozzle.

57. The method of claim 56, wherein said step a) comprises retrofitting said flight vehicle with said thrust vector control apparatus.

58. The method of claim 56, wherein said thrust vector control apparatus provided in said step a) is integral with said flight vehicle.

59. The method of claim 56, wherein said step c) comprises moving said exhaust deflector in a straight line so that every point on said exhaust deflector follows a parallel path and no rotation takes place.

60. The method of claim 56, wherein said step c) comprises moving said exhaust deflector by a combination of rotational motion with said translational motion.

61. The method of claim 56, wherein said step c) comprises moving a single one of said exhaust deflector downstream of said fixed nozzle.
